(19) United States
(12) Patent Application Publication
(10) Pub. No.: US 2005/0199671 A1
(43) Pub. Date: Sep. 15, 2005

(54) Vehicle load support

(76) Inventor: Rex W. Riley, San Diego, CA (US)

Correspondence Address: DONN K. HARMS;PATENT & TRADEMARK LAW CENTER, SUITE 100, 12702 VIA CORTINA, DEL MAR, CA, 92014, US

(21) Appl. No.: 10/798,984

(22) Filed: Mar. 11, 2004

(51) Int. Cl. B60R 9/06

(52) U.S. Cl. 224/512; 224/513

(57) ABSTRACT

The vehicle load support is externally attached to the rear of a vehicle and consists of an A-frame configuration with an angular support brace having a polarity of orifices to supply multiple load attachment points. At the distal ends of the tubular members are spring-loaded latching couplers attaching to the steel eye bolts on the vehicle for quick attachment and release. A yoke style strap is attached to the tubular members designed to be self-centering with any shifting of the load. A carabineer, or spring loaded quick release attaching clasp is fixably attached to the vehicle by the means of a secondary strap to lower the device to access the rear of the vehicle. Two unique angles in the construction of the vehicle load support vector the weight loaded on the device when elevated, down and against the eye bolts minimizing the rattling and resisting the movement forward when the brakes are applied.

### FIELD OF THE INVENTION

This invention relates to load management for vehicles such as autos, trucks, and watercraft. More particularly it relates to the field of racks, carriers or load support devices which may be externally attached to such vehicles to expand the cubic capacity and lifting capacity which is virtually non-existent in modern vehicle designs. The embodiments of the device herein disclosed may be temporarily attached to the rear of motor vehicles to expand the cargo carrying capacity and provides unique features that make it inexpensive to manufacture, easily packaged for shipping, and able to support up to two hundred pounds on the rear of a motor vehicle. In particular, the device herein disclosed and described relates to multipurpose type devices which integrate structural components of the vehicle and the external carrier such that they provide high strength, light weight, small size with high capacity and improved vehicle handling once loaded.

### BACKGROUND OF THE INVENTION

Luggage carriers on the first motor vehicles were actually removable trunks that were attached to folding racks on the back of the automobiles. With the advent of the automobiles through the years trunks for cargo which originally mounted external to the cabin were incorporated as an integral part of the entire vehicle design. However, the cargo storage area on most passenger vehicles is still conventionally being called the trunk. Through the evolution of the automobiles today the economy cars are tending to get smaller with less or no carrying capacity in the trunk or rear. One vexing problem in the case of the sport Jeeps and other SUVs is the total lack of trunk within the confines of the vehicle, particularly in times where all the seating space is occupied by riders. This lack of cargo area is also exacerbated with many luggage-bearing occupants in the vehicle even in instances where the spare tire is hung off the rear of the vehicle.

Other innovations owing to decreased manufacturing and the quest for higher mileage in small modern vehicles are their plastic bumpers. While weight saving, such bumpers lack the ability to support added weight. Further, laws in most states dictate that loads may extend up to two feet past the bumper of a vehicle with loads extending past that requiring a red flag. Conventional racks, carriers and load support devices available on the market are single purpose carriers used for carrying sporting goods like bicycles, motorcycles, golf bags, etc. Other load support specialty devices are available for transport of handicapped devices like wheelchairs and electric carts. Most of the larger carriers attach to an existing trailer hitch socket unless they are constructed as a permanent part of the vehicle. Such carriers are therefor inherently cumbersome and not easy to remove. Further, since it is hard to find a place to store these cumbersome devices, they are most often kept permanently on the backs of the vehicles even when not being used, thereby creating single use devices destined to remain on one vehicle. Other problems arise when carriers obstruct access to the back of the vehicle so that doors will not open or spare tires are difficult to remove.

As such, what is needed is a convenient way to convert the potential of a vehicle's rearward cargo space to use temporarily and within minutes when required. Such a device should not compromise the vehicle and should promote vehicle efficiency, thereby having a positive ecological impact on the planet. Such a device should be engageable easily on a variety of vehicles from pick-up trucks to boats and motor homes.

With the purchase of most new Sport Utility Vehicles such as the widely available Jeep Wrangler®, buyers will immediately discover the lack of carrying capacity within the vehicle and the need for additional carrying capabilities. The device herein disclosed provides a new and unique vehicle load support device to provide cargo carrying capacity rearward of such vehicles and solves the aforementioned problems of existing racks available for this purpose. This utility is made available by the provision of such a device which has a variety of attachment means for easy attachment to and removal from the vehicle and which pivots out of the way if necessary. Such an increase in utility is made available by the device which can be stored either in the interior of the vehicle or in a small storage space.

### REFERENCES CITED

U.S. Pat. No. 3,655,082 of Dennis J. Garrett describes a cycle supporting base beam that projects horizontally from the lower end of a dogleg supporting post pivoted on a mount attached to an automotive vehicle. The base beam is tilted sideways away from the vehicle, and wheel guards carried by the base beam and its supporting post are offset from the vehicle farther than the base beam to hold the wheels of a cycle so that the cycle leans away from the vehicle. The portion of the base beam remote from the supporting post is mounted to tilt downward from the post-attached portion of the base beam to provide a ramp for loading a cycle onto the carrier. The carrier can be swung away from the vehicle to facilitate loading and the base beam can be latched in position close alongside the rear of the vehicle during travel.

This patent describes a heavy-duty carrier capable of holding a motorcycle that is permanently attached to a vehicle or will take a great deal of time to remove from the motor vehicle. It does not, however, teach the lightweight, easily removed and attached, flexible characteristics of the vehicle load support herein disclosed.

U.S. Pat. No. 3,724,694 of Lynn E. Wilson teaches of an invention that relates to a load carrying attachment designed for mounting on the rear of a motor vehicle in a cantilevered fashion, supported at one point by a standard trailer hitch, preferably having ball hitch attachment and at points located underneath the vehicle preferably at opposite sides of the spring. There is a centrally pivotal load carrying platform which can be tilted to either side to permit loading and unloading of the device, there being a lateral supporting means affixed to the supporting frame and to points at opposite sides of the rear of the vehicle bumper, the opposite sides of the platform being releasably attached to the supporting means to permit tilting of the platform about the central pivot.

This is another patent that describes a heavy-duty carrier capable of holding a motorcycle or other heavy objects with a tilting capability to facilitate a loading ramp. Here again it does not indicate the lightweight, easy to attach and remove characteristics of the vehicle load support that pivots down to access the back door or for the removal of the spare tire.

U.S. Pat. No. 3,796,333 of Kenneth W. Goldstein discloses a carrier unit that is removably secured on a supporting bar member rigidly attached to a vehicle frame, the carrier unit including a mounting portion engaging and locking upon a mounting adapter carried by the bar member to obviate relative movement therebetween and a carrier deck attached to the mounting portion.

This patent is a detachable carrier specifically for vehicles, most commonly motorcycles. It does present unique lightweight features for the heavy load of a motorcycle that it is intended to support, but it does not indicate the lightweight, easy to attach and remove characteristics of the vehicle load support, which is not intended to support any form of motorcycle or load that may exceed two hundred pounds.

U.S. Pat. No. 3,822,801 of William A. Morgan describes a rack for loading and transporting an article, such as an animal carcass, which can be mounted on a vehicle bumper. The rack includes a tubular frame and tubular cross-members bent in a V-shape forming two sections. Adjustable flexible straps connect opposite edges of the frame sections to a vehicle bumper permitting its platform to be raised from a ground-contacting loading position to a substantially horizontal article transporting position.

This patent describes a rack for loading and transporting an article such as an animal carcass which can be mounted on a vehicle bumper. Although this patent does pivot down in a similar manner to the vehicle load support, it has been designed to attach to the bumper of the vehicle and extend out horizontally in excess of the two-foot limit, requiring a red flag when in use. The bumpers of the new cars are made of plastic and will not take the loads required by this device.

U.S. Pat. No. 3,937,376 of Marlin B. Ewing tells of a wheelchair support that is attached to and extends from the bumper of an automobile and may be swung upwardly out of the way when not in use. A support frame for confining the wheels comprises members which define wheel recesses on opposite sides of an intermediate member, which carries an adjustable retaining member. The frame is supported on pivoted arms attached to a mounting frame having adjustable clamps, which fit on and tighten to a conventional automobile bumper. A collapsed wheelchair is tilted upwards to place the large wheels in the well. Downward rotation of the wheelchair on the support frame causes the wheelchair frame to engage the retainer, which secures the wheelchair in place.

This patent is centered on the support of wheel chairs from vehicles and does not describe any similarities to the vehicle load support.

U.S. Pat. No. 4,213,729 of Clarence W. Cowles et al. discloses a multi-purpose carrier for external attachment to a land vehicle, said carrier conceived for carrying objects, which are too large or cumbersome to carry inside the vehicle. The carrier comprises a retractable platform which holds the objects, wherein the platform is rotatably pivotal through two separate movements, one such rotational movement being about an axis which is parallel to the longitudinal front-to-rear central axis of the land vehicle, and by this latter rotational movement the carrying platform is lowered at an angle with one end juxtaposed adjacent to the ground near the vehicle so that an inclined plane is formed to facilitate the loading movement of the object onto the platform from the ground, and from this latter inclined position the carrying platform is then rotated upwardly to a level position for the carrying position. The other rotational movement of the carrying platform is about a transverse axis, which is perpendicular to the longitudinal front-to-rear central axis of the vehicle. This lateral rotational movement is used to tilt the platform, when empty, into an upright vertical position adjacent to the side of the land vehicle for storage positioning when not used.

This patent discloses a multi-purpose carrier that has been well-engineered with its primary use carrying wheelchairs. The mechanics of this device requires it to pivot on two axes while still supporting a sizeable load making it very cumbersome when not attached to the vehicle. The weight and size of this device also makes it difficult to attach and remove from the vehicle and in most cases it is left permanently on the vehicle. It does not have the lightweight, easy attachment and removal characteristics of the vehicle load support.

U.S. Pat. No. 4,221,311 of Sylas Penn additionally describes a luggage carrier comprising a pair of spaced apart bumper guards for mounting on the bumper of a motor vehicle, a luggage rack frame mounted between the bumper guards, said luggage rack frame being mounted such as to be pivotal on an axis parallel to the bumper from a horizontal position to a vertical storage position and further being removably mounted to one of said bumper guards and hingedly mounted to the other of said bumper guards so as to be pivotal about a substantially vertical axis from the horizontal use position to a horizontal removal or curb loading position allowing trunk or tailgate access.

This patent describes another device that relies on a rigid bumper for a means of attachment and carries the load in a horizontal position from the vehicle. It does not describe the lightweight features and the unique means of attachment disclosed by the vehicle load support.

U.S. Pat. No. 4,403,716 of Gerald I. Carlson et al. discloses a support rack for vehicles, i.e., automobiles and the like which is particularly adapted for alternate support and storage of bicycles in one position and for the storage of general materials such as trunks, trash barrels, camping equipment and the like in an alternate position. The storage rack includes a frame which in the bicycle supporting position is positioned in an upright attitude and in the general material supporting position is in a generally horizontal position vis-à-vis the rear or front end of the vehicle on which it is supported. The rack is preferably positioned in an area of low air turbulence at the rear end of the vehicle.

This patent, although it has a variety of uses, describes another device that relies on a rigid bumper for a primary means of attachment. This device can be installed in several configurations but it requires a variety of tools to mount and make adjustments to. It does not have the lightweight conveniences of the vehicle load support.

U.S. Pat. No. 4,915,276 of Ermin Devito teaches of a mounting assembly for a carrier accessory for vans and automobiles which is adapted to be removably secured to a standard tow hitch and to provide sufficient ground clearance to allow simultaneous use of the tow hitch, the mounting assembly comprising a pair of mounting brackets slidably insertable and securable in the ends of the tow hitch, the mounting brackets having outwardly extending arms for receipt of a horizontal leg of the mounting frame for the carrier assembly, the horizontal legs slidably insertable and securable within the mounting brackets, these legs shaped so as to provide a frame platform for securing the carrier accessory.

This patent teaches of a rigid device that is relatively easy to attach and remove from a vehicle, but when attached and loaded, it makes the rear of the vehicle extremely difficult to access. It does not have the ability of being lowered down out of the way or any of the lightweight conveniences of the vehicle load support.

U.S. Pat. No. 5,033,662 of Patrick Godin describes a readily disassembled carrier including a frame having projecting arms that are telescopically engaged with mated tubular pieces attached to the chassis of the vehicle with which the carrier is to be used, and an assemblage of removable panels that cooperate to form a container on the frame. Projecting blocks are provided to limit insertion of the arms into the tubular pieces and sockets on the frame seat the ends of posts provided on the panels, inserted downwardly thereinto, with flanges on corner bracket pieces slipping into one another for inter-engagement of adjacent panels.

This patent describes a device capable of carrying relatively large loads attached to the chassis of a vehicle. When excessive weight is placed at the rear of a vehicle it will tend to lift the front tires. This may be very dangerous if the vehicle is not big enough to support the load, thus limiting the type of vehicles on which it may be safely used.

U.S. Pat. No. 5,224,636 of Dayne Bounds discloses a utility rack for being attached to a vehicle and for carrying a load. The rack includes a platform member for supporting the load, a first arm member having a first end for being attached to the vehicle and having a second end, a second arm member having a first end for being attached to the vehicle and having a second end, a first slide for slidably attaching the second end of the first arm member to the platform member, and a second slide for slidably attaching the second end of the second arm member to the platform member.

This patent discloses a very stable utility rack that is relatively easy to attach to the back of a vehicle but is rather cumbersome when it is removed from the vehicle, and when it is on the vehicle and loaded, it makes the rear completely inaccessible.

None of the foregoing prior art teaches or suggests the particular unique pivoting features of the herein disclosed vehicle load support using a triangulated attachment to load align forces from the carrier to the vehicle super structure yet still provide an ease of attachment and removal requiring a simple clasp and virtually no tools. While not intended to support excessive amounts of weight, it conveniently provides an exterior location to carry cargo and articles without restricting the accessibility to the rear of the vehicle or to the spare tire. Shock and vibration dampening are provided by the device's unique articulating couplers and flexible connections to thereby impart a smooth and quiet ride to the vehicle in spite of the load being carried on its exterior. Additionally, by integrating the load support into the vehicle structure and retaining the load in close proximity to the vehicle, the device maintains the cargo within the intended load area rearward of the vehicle while concurrently directing the force of the cargo weight such that front end lifting is eliminated and proper weight is still imparted to the front tires.

In this respect, before explaining at least one embodiment of the invention in detail, it is to be understood that the invention herein described and disclosed is not limited in its application to the details of construction and to the arrangement of the components set forth in the following description or illustrated in the drawings. The invention is capable of other embodiments and those skilled in the art will realize it may be practiced and carried out in various ways, all of which are intended to be in the scope of this patent. Also, it is to be understood that the phraseology and terminology employed herein are for the purpose of description and should not be regarded as limiting in any fashion.

### SUMMARY OF THE INVENTION

The vehicle load support in a preferred embodiment of the disclosed device is structured in an A-frame configuration of tubular members and an angular support brace. A plurality of orifices or other means of load attachment are arranged on a horizontal surface of the angular support brace to supply multiple load attachment points along with reducing the weight of the overall device. At the distal ends of the tubular members are a means of attachment to the vehicle in the form of spring-loaded latching couplers adapted for cooperative engagement over steel eye bolts engaged upon the vehicle frame.

A yoke style strap is attached to the left and right side tubular members. The yoke style strap will be made of nylon or spectra type of non-elastic material to eliminate stretching but designed to be self-centering with any shifting of the load that is attached to the vehicle load support. A carabineer, or spring loaded quick release attaching clasp is fixably attached to a secondary strap that is itself attached to the vehicle with a secondary self-centering yoke going through two pulleys. The secondary strap preferably passes through a louver orifice in the back door of the vehicle. If no orifice exists, an orifice may be formed for the purpose unless a covenant attachment point can be made on the exterior of the vehicle for the aforementioned pulley and yoke configuration.

When the secondary strap passes through the louver or orifice in the back door of the vehicle, it translates down through a cushioning tubular member that covers and protects the secondary strap. The yoke style strap, the secondary strap and the secondary self-centering yoke are all made from a synthetic material such as nylon or spectra type of material which prevents elongation or stretching of strap and yoke during operation of the device to thereby avoid any unnecessary bouncing of the vehicle load support during vehicle travel.

Two unique angles in the construction combine to yield a determined angle when the vehicle load support is raised with cargo attached and operate to vector or direct the force of the weight of the device and the cargo loaded on the device downward and inward against the eye bolts minimizing the rattling and resisting the movement forward of the load and pivoting of the tubular members when the brakes are applied during vehicle movement. A variety of convenience straps can be attached to the device as a means for holding a wide variety of loads and cargo onto the device during use.

The first preferred alternate embodiment of the vehicle load support consists of a tubular member having the left and right side tubular members with bends to yield the determined angle at the lower section on the distal ends to produce parallel alignment adapted for engagement with mating ends of a lower section. A fixed engagement is made by the co-operative engagement of the reduced sections within the distal ends of the lower section. The angular support brace is in the same respective location having a polarity of orifices arranged on the horizontal surface to supply multiple load attachment points while concurrently reducing the weight. The distal ends of the tubular member are adapted for rotational engagement with bumper or vehicle mounted eye bolts using spring loaded latching couplers.

An optional rigid support member with the pick-up tailgate clamp end may be used to make a rigid attachment between one or both of the side tubular member on the vehicle load support. The tailgate clamp end is connected to a clamp ring by the means of a tubular member.

An alternate attachment means may be employed to engage the device to a conventional trailer hitch socket on a vehicle that does not have the spare tire mounted on the back or requires access to the rear area. The alternate attachment means consists of a T-section with the conventional square section that inserts into the trailer hitch orifice with a locking pin. A cross member on the alternate attachment means has the eye bolts attached to the front face and a curved tubular member with two optional support members. One or a plurality of optional rigid support members can be used and would have clamp rings at both ends.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. It is important, therefore, that the claims be regarded as including such equivalent construction insofar as they do not depart from the spirit and scope of the present invention.

### THE OBJECTS OF THE INVENTION

An object of the disclosed device is the provision of a load support that is easily and conveniently integrated into the structure of a vehicle which supports cargo during travel while imparting forces to the vehicle frame in a manner that stabilizes the load and concurrently minimizes front lift on the vehicle.

Another object of the disclosed device herein is the provision of a cargo carrying device which will transport the intended cargo in a manner wherein it cannot contact the body of the vehicle, thereby avoiding scratching the paint of the vehicle. An additional object of the disclosed device is the provision of a load support that achieves an integrated engagement with the vehicle frame and body during use.

Yet another object of the vehicle load support disclosed herein is to create a convenient means to carry and support cargo elevated and rearward of the transporting vehicle.

Another object of the vehicle load support is to create a device that is easily and quickly attached and removed from the rear of a motor vehicle and provides internal access to the vehicle through the rearward door when loaded.

An additional object of the vehicle load support is to create a device that is relatively small and may be stored within the vehicle or in the garage not taking up much space.

A further object of the vehicle load support is to create a device that is adaptable to a wide variety of vehicles with several attachment means.

Yet another object of the vehicle load support is to create an inexpensive device for carrying articles on the rear of motor vehicles.

A still further object of the vehicle load support is to create a device that will easily pivot down out of the way for accessing the rear door or spare tire of the vehicle.

Another object of the vehicle load support is to create a device that will pivot down as an added convenience for attaching cargo to it.

Yet an additional object of the invention herein is providing a device to transport cargo suspended from a mount on the vehicle in a manner that avoids ground contact on uneven terrain.

An additional object of the invention is the provision of a cargo carrying device which insulates the vehicle from transmitted stress, vibration, and shock of the load.

A final object of the vehicle load support is to increase the capability of vehicles to carry cargo that will not fit conveniently into the passenger compartment.

These together with other objects of the invention along with the various features of novelty which characterize the invention are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred and alternate embodiments of the invention. There has thus been outlined rather broadly the more important features of the invention in order that the detailed description thereof that follows may be better understood, and in order that the present contribution to the art may be better appreciated. There are additional features of the invention that will be described hereinafter and which will form the subject matter of the claims appended hereto.

### BRIEF DESCRIPTION OF THE DRAWINGS

The accompanying drawings which are incorporated in and form a part of this specification illustrate embodiments of the invention and together with the description serve to explain the principles of this invention.

FIG. 1 depicts a perspective view of the vehicle load support attached to a vehicle illustrated as a Jeep Wrangler® in phantom.

FIG. 2 depicts a side view of the vehicle load support.

FIG. 3 depicts a side view of one of the spring loaded latching couplers with the mating eye bolt shown in section.

FIG. 4 depicts a rear view of the preferred embodiment of the vehicle load support.

FIG. 5 depicts a rear view of the first alternate embodiment of the vehicle load support.

FIG. 6 is a perspective view of the optional rigid support member with the pick-up tailgate clamp end.

FIG. 7 depicts a perspective view of the alternate attachment means to a conventional trailer hitch socket.

### DETAILED DESCRIPTION OF THE PREFERRED EMBODIMENTS

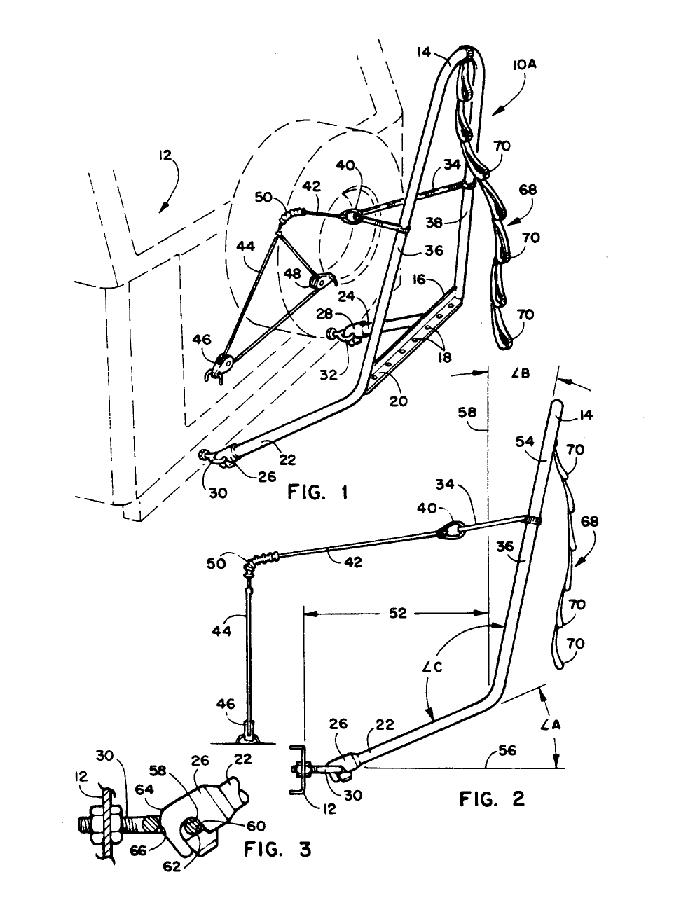

Referring now to the drawings, wherein similar parts of the invention are identified by like reference numerals, there is seen in FIG. 1 a perspective view of the first preferred embodiment of the vehicle load support 10A engaged upon the rear of a vehicle 12 illustrated in phantom. The vehicle load support 10A in this first preferred embodiment is shaped substantially in an A-frame configuration consisting of a tubular member 14 with an angular support brace 16. A plurality of orifices 18 is arranged and communicate through the horizontal surface 20 of the angular support brace 16 to supply multiple load attachment points along with reducing the weight.

At the distal ends 22 and 24 of the tubular member 14 are located a rotational means of attachment to vehicle mounted eyebolts 30 in the form of spring loaded latching couplers 26 and 28 attaching to the steel eye bolts 30 and 32. The eye bolts 30 and 32 are shown attached to the frame of the vehicle 12 as they would be on a Jeep Wrangler®, but it must be understood that the eye bolts 30 and 32 could be attached in a variety of locations on many different vehicles and the spring loaded latching couplers 26 and 28 could attach to different styles of engagement devices, like tow hooks, pins, etc. and all still remain within the intended scope of this patent. Further, those skilled in the art will no doubt realize that a variety of means of attachment of the vehicle load support 10A and 10B to the rear end of a vehicle may be used other than those shown and all such means for attachment are anticipated by this patent application.

A yoke style strap 34 is attached to the left side of the tubular member 36 and right side tubular member 38. The yoke style strap 34 will be made of non-elastic nylon or spectra type of material but designed to be self-centering with any shifting of the load that is attached to the vehicle load support 10A. A means for releasable engagement of the strap 34 to a secondary strap 42 is provided in the form of a carabineer, or spring loaded quick release attaching clasp 40 which is fixably attached to the secondary strap 42. The secondary strap 42 is also constructed of a non-stretch or non elastic fabric such as nylon so that once the clasp 40 is engaged with the secondary strap 42, rearward movement is minimized.

Means for attachment of the secondary strap 42 to the vehicle 12 is shown provided by a secondary self-centering yoke 44 going through pulleys 46 and 48. The secondary strap 42 passes through a louver orifice in the back door of the vehicle 12 to its engagement with the yoke 34. If no orifice exists, such as in a retrofit of an existing vehicle, an orifice must be drilled or otherwise formed unless a covenant attachment point for the secondary self centering yoke 44 can be made on the exterior of the vehicle 12. When the secondary strap passes through the existing orifice in the back door of the vehicle 12, it translates down through a cushioning tubular member 50 that covers and protects the secondary strap 42. A grommet 51 or other aperture means may be placed in the door. As noted, the yoke style strap 34, the secondary strap 42 and the secondary self-centering yoke 44, all will be made from non-elastic nylon or spectra type of material to avoid any unnecessary bouncing of the vehicle load support 10A. It should be further noted that while the preferred means to hold the vehicle load support in an elevated position is shown and described above through the engagement of the yoke style strap 34 to the secondary strap 42, other means to hold the vehicle load support elevated might be employed without departing from the spirit and scope of this application, and all such adaptations or alternate means to hold the vehicle load support in an elevated position are anticipated.

In use, the vehicle load support 10A with its attached spring loaded latching couplers 26 engaged over the eye bolts 30, provide a rotational means of engagement of the distal ends of the tubular member 14 to the vehicle. In such an engagement the vehicle load support 10A may be rotated away from the vehicle to a lowered position where cargo may be attached and then rotated toward the vehicle to its raised position with attached cargo suspended above the ground. The attachment of the yoke style strap 34 to the spring loaded quick release clasp 40 will thereafter maintain the vehicle load support 10A in the elevated position with the cargo held above the ground.

When in the elevated position, the lower sections of the tubular member 14 are positioned to Angle C which causes the lower sections of the tubular member 14 to be engaged to the vehicle at Angle A which therein imparts the force of the cargo attached to the tubular member 14 directly into the rear of the vehicle as well as the weight of the cargo. This minimizes the lifting forces imparted to the front of the vehicle which cause light steering and also maintains the spring loaded latching coupler 26 in a forced engagement to the eye bolt 30 thereby minimizing rattling during use.

FIG. 2 is a side view of the vehicle load support 10A attached to a vehicle 12 by the means of the spring loaded latching couplers 26 and 28 and the attaching strap 42 creating the space 52 where the vehicle load support 10A upright section 54 is away from the vehicle 12 allowing room for the spare tire. Also illustrated is the angle A, between 0 degrees and 30 degrees, the angle that the left side tubular member 36 and the right side tubular member 38 are above a horizontal line 56 and angle B, between 0 degrees and 45 degrees, the angle of inclination of the upper section 54 of the vehicle load support 10A away from a perpendicular line 58 of the back of the vehicle 12. Angle C is the resulting angle in the left side tubular member 36 and the right side tubular member 38 of the vehicle load support 10A, whereby the weight of the load is directed against the eye bolts 30 and 32 that are attached to the vehicle 12. Space 52 assures that the vehicle load support 10A is far enough from the back of the vehicle 12 that it does not interfere with an attached spare tire. One or more convenience straps 68 with one or more attachment loops 70 can be secured to the vehicle load support 10A for securing or attaching the load which is constrained within space 53 defined by Angle A and area 55.

FIG. 3 depicts a side view of one of the spring loaded latching couplers 26 with the mating eye bolt 30 shown in cross section clarifying the location of the clevis portion 58 and the pressure exerted on eye bolt outer surface 60 by the coupler inner surface 62 of the spring loaded latching coupler 26. Additional and equal forces are exerted on the coupler outer surface 64 against the eye bolt inner surface 66. This loose link style of connection along with angle A, the angle that the left side tubular member 36 and the right side tubular member 38 are above a horizontal line 56 and angle B, the angle of inclination of the vehicle load support 10A away from a perpendicular line 58 of the back of the vehicle 12, disperse the load so that a minimum amount of rattling occurs and the load resists moving forward when the breaks are applied. By releasing the spring loaded quick release attachment 40, the vehicle load support 10A will pivot on the eye bolts 30 and 32 to rest on the ground to easily detach from the rear of the vehicle 12.

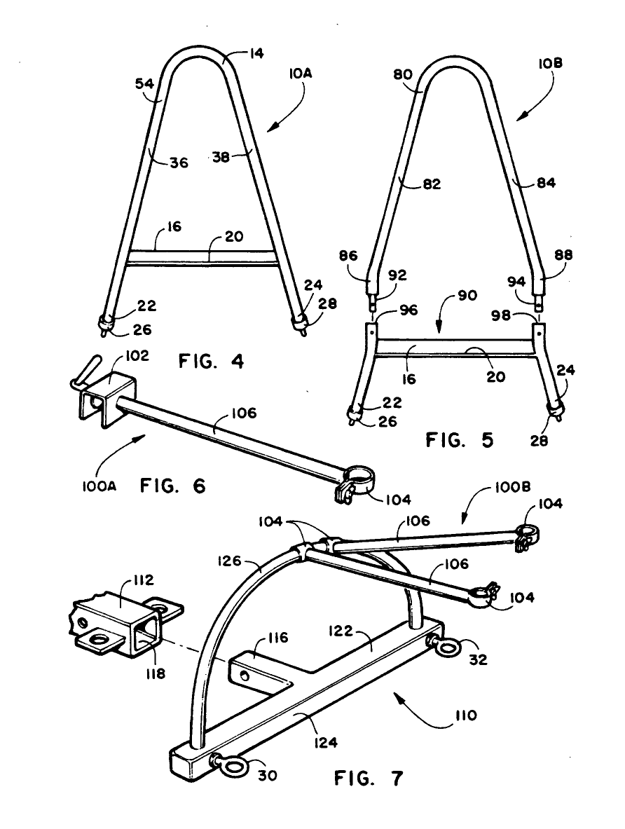

FIG. 4 depicts a rear view of the preferred embodiment of the vehicle load support 10A in an A-frame configuration consisting of a tubular member 14 with an angular support brace 16. At the distal ends 22 and 24 of the tubular member 14 are the spring loaded latching couplers 26 and 28. It must be made clear at this time that the A-frame or stinger shape though preferred may be square, rounded or any other geometric shape and still be within the scope of this patent.

FIG. 5 depicts a rear view of the first alternate stinger embodiment of the vehicle load support 10B with the upper tubular member 80 having the left side tubular member 82 and the right side tubular member 84 with bends on the distal ends 86 and 88 to produce parallel alignment with the mating ends of the lower section 90. Fixed engagement is made by the insertion of the reduced sections 92 and 94 within the lower frame section distal ends 96 and 98.

Angular support brace 16 is in the same respective location with a polarity of orifices 18 arranged on the horizontal surface 20 of the angular support brace 16 to supply multiple load attachment points along with reducing the weight. At the distal ends 22 and 24 of the lower frame section 11 are the spring loaded latching couplers 26 and 28.

FIG. 6 is a perspective view of the optional rigid support member 100 with the pick-up tailgate clamp end 102 that may be used to make a rigid attachment between one or both of the left side tubular member 36 and the right side tubular member 38 on the vehicle load support 10A or the left side tubular member 82 and the right side tubular member 84 on the vehicle load support 10B. The tailgate clamp end 102 is connected to a clamp ring 104 by the means of a tubular member 106.

FIG. 7 depicts a perspective view of the alternate attachment means 110 to a conventional trailer hitch socket 112 on a vehicle 12 that does not have the spare tire mounted on the back or require ready access to the rear area of the vehicle. The alternate attachment means 110 consists of a T-section 114 with the conventional square section 116 that inserts into the trailer hitch orifice 118 of the trailer hitch socket 112 with a locking pin going through orifice 120. A cross member 122 on the alternate attachment means 110 has the eye bolts 30 and 32 attached to the front face 124 and a curved tubular member 126 with two optional support members 100B. The optional rigid support members 100B have clamp rings 104 at both ends of the tubular member 106.

The vehicle load support 10A and 10B shown in the drawings and described in detail herein disclose arrangements of elements of particular construction and configuration for illustrating preferred embodiments of structure and method of operation of the present invention. It is to be understood, however, that elements of different construction and configuration and other arrangements thereof, other than those illustrated and described, may be employed for providing an vehicle load support 10A and 10B in accordance with the spirit of this invention, and such changes, alternations and modifications as would occur to those skilled in the art are considered to be within the scope of this invention as broadly defined in the appended claims.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

1. A vehicle load support for engagement to a vehicle comprising
an elongated frame member having a first side member and a second side member;
said first side member and said second side member extending between an upper section with an engagement end, and a lower section with an attachment end;
said attachment end adapted for rotational engagement with the rear of a vehicle in a mounted position;
said frame member, in said mounted position, rotatable between an elevated position, and a lowered position wherein said upper section is positionable to contact one of the ground or cargo sitting on the ground;
means to maintain said frame member in said elevated position;
means to suspend said cargo from said upper section of said frame member; and
whereby said upper section of said frame member engaged in said rotational engagement with said vehicle, may be rotated adjacent to said cargo on said ground adjacent to said vehicle, and thereafter rotated to, and removably maintained in, said elevated position, with said cargo suspended above said ground engaged upon said upper section.

2. The vehicle load support of claim 1 additionally comprising:
said lower section of said frame member in angled engagement with said upper section at a determined angle;
said determined angle imparting a vectored force comprising substantially the combined weight of said frame member and said cargo, when said frame member is in said elevated position; and
said vectored force communicated substantially toward said rear of said vehicle at said determined angle when said is maintained in said elevated position.

3. The vehicle load support of claim 1 additionally comprising:
said engagement end of said frame member positioned at a point on said frame member substantially equidistant between two distal ends of said frame member at said attachment end;
said first side member extending between said engagement end and one of said two distal ends;
said second side member extending between said engagement end and the other of said two distal ends; and
means for rotational engagement of each of said two distal ends with the rear of said vehicle.

4. The vehicle load support of claim 2 additionally comprising:
said engagement end of said frame member positioned at a point on said frame member substantially equidistant between two distal ends of said frame member at said attachment end;
said first side member extending between said engagement end and one of said two distal ends;
said second side member extending between said engagement end and the other of said two distal ends; and
means for rotational engagement of each of said two distal ends with the rear of said vehicle.

5. The vehicle load support of claim 1 wherein said means to maintain said frame member in said elevated position comprises:
a first flexible tether engaged at a first connection to said first side member and at a second connection to said second side member;
said first flexible tether having a tether center area between said first connection and said second connection;
a second flexible tether engaged at a first end to said vehicle and having a second end; and
means to slidably engage said second end of said second flexible tether to said center area of said first flexible tether.

6. The vehicle load support of claim 2 wherein said means to maintain said frame member in said elevated position comprises:
a first flexible tether engaged at a first connection to said first side member and at a second connection to said second side member;
said first flexible tether having a tether center area between said first connection and said second connection;
a second flexible tether engaged at a first end to said vehicle and having a second end; and
means to slidably engage said second end of said second flexible tether to said center area of said first flexible tether.

7. The vehicle load support of claim 3 wherein said means to maintain said frame member in said elevated position comprises:
a first flexible tether engaged at a first connection to said first side member and at a second connection to said second side member;
said first flexible tether having a tether center area between said first connection and said second connection;
a second flexible tether engaged at a first end to said vehicle and having a second end; and
means to slidably engage said second end of said second flexible tether to said center area of said first flexible tether.

8. The vehicle load support of claim 4 wherein said means to maintain said frame member in said elevated position comprises:
a first flexible tether engaged at a first connection to said first side member and at a second connection to said second side member and having a tether center area between said first connection and said second connection;
a second flexible member engaged at a first end to said vehicle and having a second end; and
means to slidably engage said second end of said second flexible member to said first flexible tether at said center area.

9. The vehicle load support of claim 1 wherein said means to maintain said frame member in said elevated position comprises:
at least one support rod engageable at a first end with a mount in communication with said vehicle; and
said support rod removably engageable at a second end with said frame member.

10. The vehicle load support of claim 2 wherein said means to maintain said frame member in said elevated position comprises:
at least one support rod engageable at a first end with a mount in communication with said vehicle; and
said support rod removably engageable at a second end with said frame member.

11. The vehicle load support of claim 1 wherein said attachment end is adapted for rotational engagement with said vehicle by employing a rotational means of attachment to a support bar; and
said support bar is adapted for cooperative engagement with a trailer hitch orifice mounted on said vehicle.

12. The vehicle load support of claim 2 wherein said attachment end is adapted for rotational engagement with said vehicle by employing a rotational means of attachment to a support bar; and
said support bar is adapted for cooperative engagement with a trailer hitch orifice mounted on said vehicle.

13. The vehicle load support of claim 9 wherein said attachment end is adapted for rotational engagement with said vehicle by employing a rotational means of attachment to a support bar; and
said support bar is adapted for cooperative engagement with a trailer hitch orifice mounted on said vehicle.

14. The vehicle load support of claim 10 wherein said attachment end is adapted for rotational engagement with said vehicle by employing a rotational means of attachment to a support bar; and
said support bar is adapted for cooperative engagement with a trailer hitch orifice mounted on said vehicle.

15. The vehicle load support of claim 1 additionally comprising:
said upper section being separable from said lower section.

16. The vehicle load support of claim 2 additionally comprising:
said upper section being separable from said lower section.

17. The vehicle load support of claim 9 additionally comprising:
said upper section being separable from said lower section.

18. The vehicle load support of claim 1 additionally comprising:
a support brace extending between said first side member and said second side member.

19. The vehicle load support of claim 2 additionally comprising:
a support brace extending between said first side member and said second side member.

20. The vehicle load support of claim 15 additionally comprising:
a support brace extending between said first side member and said second side member.

21. The vehicle load support of claim 1 wherein said means to suspend said cargo from said upper section of said frame member comprises:
an elongated flexible support strap; and
a plurality of support loops formed in said support strap.

22. The vehicle load support of claim 2 wherein said means to suspend said cargo from said upper section of said frame member comprises:
an elongated flexible support strap; and
a plurality of support loops formed in said support strap.
